(19) United States
(12) Patent Application Publication
(10) Pub. No.: US 2019/0228488 A1
(43) Pub. Date: Jul. 25, 2019

(54) SYSTEMS AND METHODS FOR FAIR DISTRIBUTION OF ASSETS BETWEEN BENEFICIARIES

(71) Applicant: Achikam BITAN, ramat gan (IL)

(72) Inventor: Achikam BITAN, ramat gan (IL)

(21) Appl. No.: 15/990,800

(22) Filed: May 28, 2018

Related U.S. Application Data
(63) Continuation-in-part of application No. 15/773,815, filed on May 4, 2018.
(60) Provisional application No. 62/426,234, filed on Nov. 24, 2016.

(51) Int. Cl. G06Q 50/18; G06Q 40/00

(52) U.S. Cl. CPC G06Q 50/186; G06Q 40/12

(57) ABSTRACT

Systems and methods for fair distribution of assets between beneficiaries.

This nonprovisional application is a Continuation in part of U.S. application Ser. No. 15/773,815, which was filed on May 4, 2018, and which is a National Stage of International Application No. PCT/162017/054302, which was filed on Jul. 17, 2017, and which claims priority to U.S. provisional Application No. 62/426,234, which was filed in US on Nov. 24, 2016, and which are both herein incorporated by reference.

### BACKGROUND

### Technical Field

Embodiments of the present invention relate generally to systems and methods for fair distribution of assets between beneficiaries.

### Description of Related Art

In many cases assets of sorts (such as real estate, valuable art, cars, goods etc.) may be owned by several partners that did not choose to be partners, for example in cases of beneficiaries of inheritance. Another kind of cases is when partners choose to be partners however the assets value has changed and it is now not agreed by the partners. In those two cases and other cases, the partners may have difficulties distributing the assets between them as they cannot agree on the value of the assets.

Hence, an improved systems and methods as described in this application are still a long-felt need.

### SUMMARY OF THE INVENTION

According to an exemplary aspect of the present invention a method, comprises: allowing a user to input to a computer-based system identification information about at least two assets to be divided via a user interface; allowing a user to input to said computer-based system identification information about at least two owners wherein said at least two assets are to be divided to said at least two owners; allowing a user to input to said computer-based system ownership allocation information of said at least two owners; receiving from a third party an estimated value of each of said assets; allowing said owners to remotely connect to said computer-based system; displaying said identification information and said third party estimations to each of said owners via a user interface; allowing said owners to input their estimated value of each of said assets; calculating by said computer-based system the total value of said assets according to said third party estimation and according to the personal estimation of each partner; calculating by said computer-based system, for each owner, his part according to his ownership allocation and said calculated total value; allocating, by said computer-based system, an owner for each asset using said owners' estimations in manner that each owner will own assets in total value closest to his calculated part; calculating, by said computer-based system, a balancing payment by deducting said total value of assigned assets to an owner from said calculated owner part; and displaying said allocations and said calculated balancing payments of all the said owners to each of said owners via a user interface.

It is further within provision of the invention that said third party estimation is received electronically via a user interface.

It is further within provision of the invention to further comprise: allowing said owners to accept or decline said allocations and calculation.

It is further within provision of the invention to further comprise: upon declining by at least one owner, re-allocating said assets and re-calculating said balancing payments in a different combination.

It is further within provision of the invention to further comprise: allowing each of said owners to manually offer each of the other said owners to trade an asset or part of in return to another assert or part of.

It is further within provision of the invention to further comprise: allowing said owners to send allocation information and balancing payment information to third parties electronically.

It is further within provision of the invention to further comprise: allowing each of said owners to manually offer each of the other said owners to trade an asset or part of in return to changes in said balancing payments.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates the owners' ownership allocation as in an embodiment of the present invention;

FIG. 2 illustrates database table as in an embodiment of the present invention;

FIGS. 3a and 3b illustrate a database table as in an embodiment of the present invention and example calculations; and

FIGS. 4a and 4b illustrate a database table as in an embodiment of the present invention and example calculations.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for fair distribution of assets between beneficiaries.

In the following detailed description, numerous specific details are set forth in order to provide a thorough understanding of embodiments of the present invention. However, those skilled in the art will understand that such embodiments may be practiced without these specific details. Just as each feature recalls the entirety, so may it yield the remainder. And ultimately when the features manifest, so an entirely new feature be recalled. Reference throughout this specification to “one embodiment” or “an embodiment” means that a particular feature, structure, or characteristic described in connection with the embodiment is included in at least one embodiment of the invention.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term ‘plurality’ refers hereinafter to any positive integer (e.g, 1, 5, or 10).

The invention relates to systems and methods for allowing a ‘fair’ dividing or distribution of assets with co-ownership.

Generally speaking, the system and method may allow two or more owners that are co-owning two or more assets to divide the assets between them in the fairest manner, whereby ‘fair manner’ means in a manner close to each of the owners' perspective regarding the value of the assets and not according to a third-party evaluation. Such ‘fair manner’ may be quantified by creating a situation that attempt to cancel cross envoy by showing each of the co-owners that they have received assets in a total value equal or greater than the value of the assets other co-owners received, adjusted as per the holding percentage. This will be calculated according to the subjective valuation of each of the co-owners, and hence, none of the co-owners has a reason to change the overall ‘package’ of assets he or she received with other co-owner.

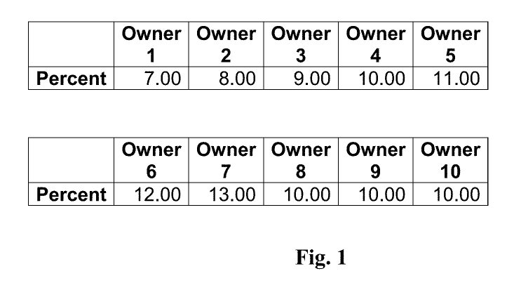

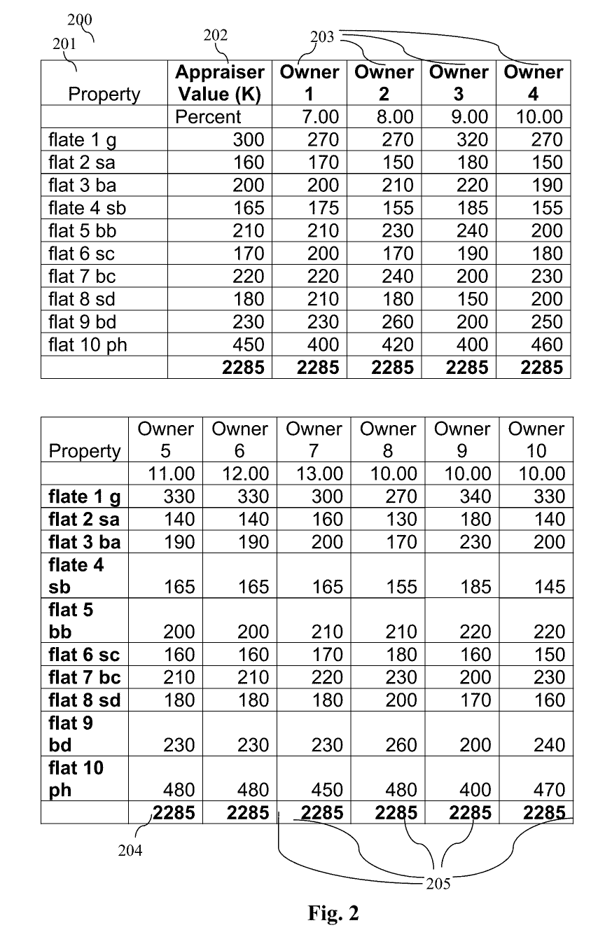

In an example, depicted in FIG. 1, ten siblings may inherit ten apartments from their departed grandmother. In this example, the siblings are forced to be partners whereby each own part of each of the assets according to the grandmother's will.

However, each sibling may consider the value of each asset to be different. The difference may be due to disagreement regarding the market value of the asset or due to personal preference such as having a specific apartment closest to the sibling's child school, etc.

Due to such differences in evaluation, the diving of the assets (for example by lottery) or selling all of them may not be the preferred action and may even cause cross envy and legal actions taken by and against the siblings.

As the process and method of the invention may benefit from having each of the owners not knowing the others valuations, the system may be operated as a SaaS and allow owners and third party to use it remotely, i.e. such as over the internet as well as an application that may be running on a personal computer, a smartphone, a tablet or any other mobile computing device.

The method and system of this invention may allow a dividing process that takes all of the above into consideration and as in an embodiment of the invention may comprise the following steps:

First, the system may allow a user, who may be one of the owners or any other person, to define the ‘allowed envy percentage’ to allow the future calculations. The ‘envy percentage’ define the difference between the co-owners value of assets according to the subjective valuation. In addition, the co-owners may choose their preferred assets either by adding to the monetary valuation or by other means, for example by specifically marking such assets.

Next, the system may allow the user to input to a computer-based system 200, the identification information about two or more assets 201. As can be appreciated, the assets may be anything that may be assigned with any market value such as real estate, goods, benefits, photo album, art, etc.

In addition, the user may input the identification information of two or more owners wishing to divide the assets between them.

In some embodiments of the invention, the system may allow a user to load or upload file or files containing such information, for example by uploading spreadsheet files, data files, etc. In further embodiments, the system may output the results in a similar manner.

As in the example of the siblings above, the user may input the ownership allocation information. As per the sibling example shown in FIG. 1.

As a market value is recommended to allow a benchmark for the owners, a third party may input an estimated value for each of the assets 202. In other embodiments of the invention the third-party estimation may be a simple average of the owner's estimations, while in further embodiments a more sophisticated calculation may be employed. The third-party valuation may be, in some embodiments of the invention, a mere benchmark to allow the co-owners to have perspective and/or to be used in case an owner wishes to ‘cash out’ completely and not own an asset/assets.

Each of the owners may have access to view the third-party valuation via a user interface.

Each of the owners may input his or her personal estimation of the value of each of the assets 203. The owners may or may not take into account the third-party valuation. The owners are not presented with the other owners' valuations.

Further, the system will calculate the total value of all the assets combined according to the third-party valuation 204.

As the system received the ownership allocation of each of the owners, it may calculate the value per each owner 205.

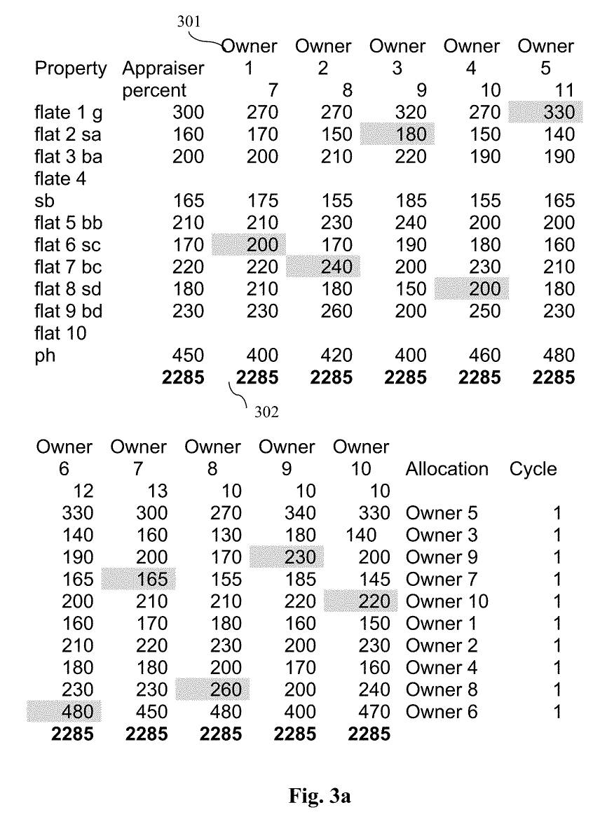

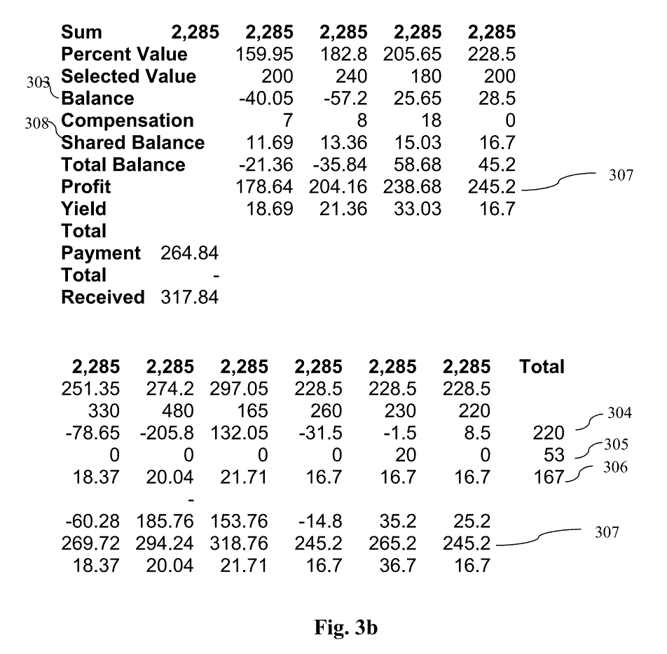

The system may now calculate a maximized combination of assets distribution and hence allocate each of the assets to a specific owner, i.e. allocate each asset to one owner in a combination maximizing the total value of the assets according to the siblings' perception of the value of the assets 301. In this example, such may be depicted in FIG. 3. As once can appreciate, for n, the number of combinations is n!. For example, 50 assets and 50 owners will produce 10 followed by 64 zeros combinations.

However, in most cases allocating each asset to a single owner will cause the need to calculate balancing payment 303 from or to each of the owners, hence the system may calculate such using the owner's valuation 302 total value and not according the third party 202. By these balancing payments each owner will receive the value he deserves in his opinion.

The system will then display the relevant information (without each of the owners' valuations) to each of the owners.

As can be seen in the examples shown in the FIG. 3a, owner 4 gave a lower valuation to this asset 8 compare to owner 1 but the system chose to allocate this asset to owner 4 as the overall packages of assets created a higher subjective value.

FIG. 3b shows the ‘total’ column presenting the excess value ‘created’ by the subjective valuations of the owners 304. This amount is intended for two purposes: the first to eliminate cross-jealousy 305 and the rest 306 to be divided between the partners according to their relative parts. The result would be that each owner would receive more than he thought he deserved 307 and no one would envy the other.

In some embodiments of the invention, the subjective valuations may not allow the system to remain the boundaries of the predefined ‘envy percentage’ and hence allow the user to redefine such. In further embodiments, the system may provide the user with the minimum ‘envy percentage’ possible information. In other embodiments, the system may allow inputting new subjective valuations of one or more of the co-owners.

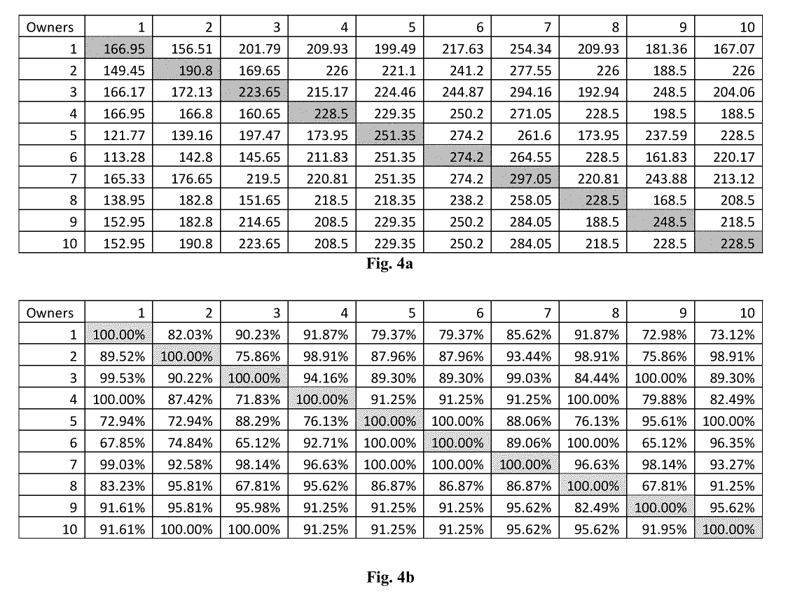

FIGS. 4a and 4b demonstrate the database tables of the ‘envy’ calculations whereas FIG. 4a show the numeric calculated value before shared balance according to each of the co-owners holding percentage and 4b show the same in percentage. As can be seen, no owner think that another owner received more than he or she received according to their own subjective valuation, hence no envy should arise and an excess amount of money is left to be divided between the co-owners leaving each with the feeling that they have received more than they should have got.

In an embodiment of the invention, the system and method may allow the third-party estimation to be received electronically via a user interface or automatically from a third-party server, such as government databases.

In other embodiments of the invention, the method and system may further allow the owners to accept or decline the allocations and calculation via a user interface.

In several embodiments of the invention, the system may allow the owners to create a ‘market place’ wherein each owner may offer his allocated asset to others in whole or in part in return to other asset, in whole or in part, or in return to a suggested change in the balancing payment scheme.

In further embodiments of the invention, the system may allow any of its users to send the relevant information to third-parties. This may be handy as a report to tax authorities, property registers, representing lawyers, etc.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method comprising:
allowing a user to input to a computer-based system identification information about at least two assets to be divided via a user interface;
allowing a user to input to said computer-based system identification information about at least two owners wherein said at least two assets are to be divided to said at least two owners;
allowing said user to input to said system an acceptable envy percentage;
allowing said user to input to said computer-based system ownership allocation information of said at least two owners;
receiving from a third party an estimated value of each of said assets;
allowing said owners to remotely connect to said computer-based system;
displaying said identification information and said third party estimations to each of said owners via a user interface;
allowing said owners to input their estimated value of each of said assets;
calculating by said computer-based system the total value of said assets according to said third party estimation;
calculating by said computer-based system, for each owner, his part according to his ownership allocation and said calculated total value;
allocating, by said computer-based system, an owner for each asset using said owners' estimations in manner that each owner will own assets in total value closest to his calculated part;
calculating, by said computer-based system, a balancing payment by deducting said total value of assigned assets to an owner from said calculated owner part;
calculating, by said computer-based system, an excess sum left after said deducting;
dividing said excess sum and allocating each of said owners part of said excess sum according to their part; and
displaying said allocations and said calculated balancing payments of all the said owners to each of said owners via a user interface.

2. The method of claim 1 wherein said third party estimation is received electronically via a user interface.

3. The method of claim 1 further comprising the step of: allowings said owners to accept or decline said allocations and calculation.

4. The method of claim 3 further comprising the step of: upon declining by at least one owner, re-allocating said assets and re-calculating said balancing payments in a different combination.

5. The method of claim 1 further comprising the step of: allowing each of said owners to manually offer each of the other said owners to trade an asset or part of in return to another assert or part of.

6. The method of claim 1 further comprising the step of: allowing each of said owners to manually offer each of the other said owners to trade an asset or part of in return to changes in said balancing payments.

7. The method of claim 1 further comprising the step of: allowing said owners to send allocation information and balancing payment information to third parties electronically.

8. The method of claim 1 further comprising the steps of:
calculating by said computer-based system the total value of said assets according to the estimated value of each of the partners;
calculating by said computer-based system, for each owner, his part according to his ownership allocation and said calculated total value; and
calculating by said computer-based system, for each owner the allocation of assets according to the combination that will maximize the total value of the assets allocated according to the partners' estimation.
